(19) United States
(12) Patent Application Publication
(10) Pub. No.: US 2008/0079596 A1
(43) Pub. Date: Apr. 3, 2008

(54) BUFFERING ALARMS

(75) Inventors: John J. Baier, Mentor, OH (US); Eric G. Dorgelo, Port Moody (CA); Kenwood H. Hall, Hudson, OH (US); Charles M. Rischar, Chardon, OH (US); David K. Johnson, Waukesha, WI (US); Dale Sapach, Roberts Creek (CA); Jan Bezdicek, Prelouc (CZ); Daniel Cernohorsky, Hradec Kralove (CZ)

Correspondence Address: ROCKWELL AUTOMATION, INC./(AT), ATTENTION: SUSAN M. DONAHUE, E-7F19, 1201 SOUTH SECOND STREET, MILWAUKEE, WI, 53204, US

(73) Assignee: ROCKWELL AUTOMATION TECHNOLOGIES, INC., Mayfield Heights, OH (US)

(21) Appl. No.: 11/537,387

(22) Filed: Sep. 29, 2006

(51) Int. Cl. G08B 21/00; G08B 29/00; G08B 1/00

(52) U.S. Cl. 340/679; 340/506; 340/309.16

(57) ABSTRACT

An industrial field device comprises an alarm generator component that creates an alarm relating to the industrial field device and a buffering component that selectively caches the alarm within a data repository. The field device can be an industrial controller or a network infrastructure device. The alarm created by the alarm generator component can be customized according to user information, including user preferences.

### TECHNICAL FIELD

The disclosed subject matter relates generally to alarms within an industrial setting, and, more particularly, relates to selectively caching alarms generated within field devices.

### BACKGROUND

Due to advances in computing technology, businesses today are able to operate more efficiently when compared to substantially similar businesses only a few years ago. For example, high speed data networks enable employees of a company to communicate instantaneously by email, quickly transfer data files to disparate employees, manipulate data files, share data relevant to a project to reduce duplications in work product, etc. Furthermore, advancements in technology have enabled factory applications to become partially or completely automated. For instance, activities that once required workers to put themselves proximate to heavy machinery and other various hazardous conditions can now be completed at a safe distance therefrom.

Further, imperfections associated with human action have been minimized through employment of highly precise machines. Many of these factory devices supply data related to manufacturing to databases (or web services referencing databases) that are accessible by system/process/project managers on a factory floor. For example, sensors and associated software can detect a number of instances that a particular machine has completed an operation given a defined amount of time. Further, data from sensors can be delivered to a processing unit related to system alarms. Thus, a factory automation system can review collected data and automatically and/or semi-automatically schedule maintenance of a device, replacement of a device, and other various procedures that relate to automating a process.

In typical control applications, alarms are generated when a process variable value lies outside a predefined expected range, when a sensed parameter lies outside an expected range, when particular user action is undertaken (such as depression of an emergency stop), and the like. These alarms provide an indication to an operator or device that an unexpected event has occurred with respect to a particular control process. In another example, alarms that are not associated with a high level of urgency can be created and logged, and may not be provided to an operator unless a more urgent, related alarm occurs. Thereafter, logs can be parsed in an effort to determine a source of failure with respect to a control process.

Conventionally, field devices produce or consume data and are monitored by a higher-level system, such as a Manufacturing Execution System (MES). These higher-level systems analyze data being produced and/or consumed on a factory floor and generate alarms if monitored data lies outside a predefined range. In large facilities, a significant number of alarms can be generated in a small amount of time, wherein order of generation depends upon an order that data is received at the high-level system (which can often depend upon communication medium, length of travel of data, etc.).

### SUMMARY

The following presents a simplified summary of subject matter described in more detail herein in order to provide a basic understanding of some aspects of such subject matter. This summary is not an extensive overview, and is not intended to identify key/critical elements or to delineate the scope of the subject matter described herein. Its sole purpose is to present some concepts in a simplified form as a prelude to the more detailed description that is presented later.

Briefly described, the subject disclosure pertains to selectively caching alarms within an industrial field device, which can be an industrial controller (such as a logic controller, a robotic controller, etc.), a press, a pump, or other suitable manufacturing device, a network infrastructure device (such as a switch, a router, a bridge, etc.) or any other suitable field device. In more detail, the industrial field device can be configured to generate alarms therein, such as when a process variable lies outside an expected range, when a sensed parameter is above or below certain thresholds, when an operator undertakes certain action (such as depressing an emergency stop push-button), and/or the like. When an alarm is created by a field device, the alarm can desirably be provided to another field device, a server that maintains alarms, a human-machine interface for display to an operator, or other suitable location. Selectively caching the alarm can be utilized to increase probability that the device/system that desirably receives the alarm will, in fact, receive such alarm.

In an example, the field device can include functionality that periodically checks connectivity of devices that are communicatively coupled thereto. Thus, prior to providing a device/system with an alarm, the field device that generated the alarm can determine connectivity of the intended recipient. If the intended recipient is not associated with sufficient connectivity (e.g., does not respond to a ping within a certain amount of time), the alarm can be selectively cached. When the device becomes associated with sufficient connectivity, the alarm can be delivered to such device.

With respect to alarm generation, such alarms can be created in accordance with current context and/or user preferences. For example, content of an alarm can alter given different context. Additionally, format and content of an alarm can be customized according to an intended recipient. More particularly, a first user may wish to receive an alarm in a first language, and a second user may wish to receive the alarm in a second language. Alarms generated by the field device thus can be customized according to context and/or user information.

To the accomplishment of the foregoing and related ends, certain illustrative aspects are described herein in connection with the following description and the annexed drawings. These aspects are indicative, however, of but a few of the various ways in which the principles of the invention can be employed and such subject matter is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates an example industrial field device that can buffer alarms.

FIG. 2 illustrates an example field device that can create alarms, associate the alarms with timestamps that accord to a synchronized time, and buffer the alarms.

FIG. 3 illustrates an example buffer component.

FIG. 4 illustrates an example industrial field device that can create alarms based at least in part upon sensed contextual data.

FIG. 5 illustrates an example system that facilitates rolling back an industrial field device or manufacturing process to a known good state.

FIG. 6 illustrates an example field device that can buffer an alarm until confirmation of receipt of the alarm is received from a device that is desirably provided the alarm.

FIG. 7 illustrates an example system that can analyze trends in alarms.

FIG. 8 is a representative flow diagram that illustrates an example methodology for selectively buffering an alarm.

FIG. 9 is a representative flow diagram that illustrates an example methodology for selectively buffering an alarm.

FIG. 10 is a representative flow diagram that illustrates an example methodology for selectively caching an alarm.

FIG. 11 is an example computing environment.

FIG. 12 is an example networking environment.

### DETAILED DESCRIPTION

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that such matter can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component may be, but is not limited to a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

Furthermore, aspects of the disclosed subject matter may be implemented as a method, apparatus, or article of manufacture using standard programming and/or engineering techniques to produce software, firmware, hardware, or any combination thereof to control a computer to implement various aspects of the subject invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of what is described herein.

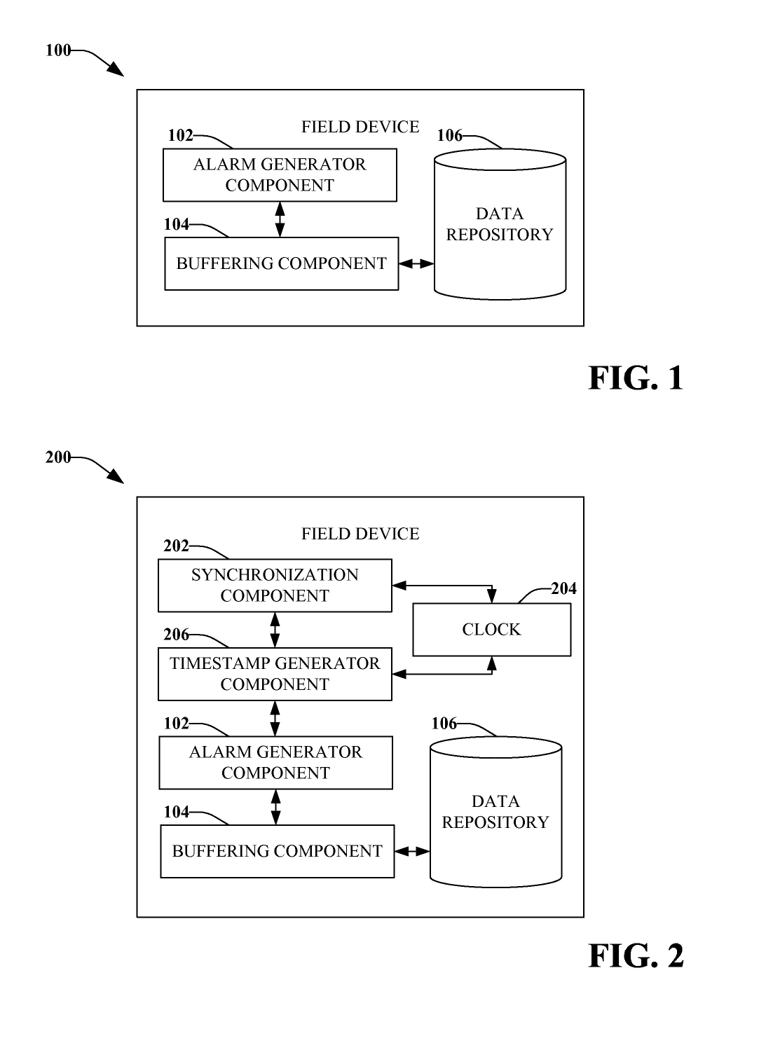

Now referring to the drawings, FIG. 1 illustrates a field device 100 wherein alarms generated therein can be buffered. The field device 100 includes an alarm generator component 102, which can analyze data produced and/or consumed by the field device 100 and determine whether an alarm should be generated based upon such analysis. For instance, the field device 100 can include memory (not shown) that retains thresholds for data produced and/or consumed by the field device 100, and if the alarm generator component 102 determines that produced/consumed data lies outside a particular threshold, the alarm generator component 102 can create an alarm. In another example, the alarm generator component 102 can create an alarm upon a user undertaking certain action, such as depressing an emergency stop button. In a specific example, the field device 100 can be a controller and can receive sensed temperatures from a sensor, wherein such temperatures should be within a particular range. If the temperatures are outside such range, the alarm generator component 102 within the field device 100 can create an alarm (which can then be delivered to an intended recipient).

The alarm generator component 102 can be associated with a buffering component 104 that can cause an alarm to be cached within a data repository 106 that is internal to the field device 100 and/or communicatively coupled to the field device 100. Therefore, for instance, if a server associated with multiple industrial field devices goes offline, individual field devices can buffer alarms and/or events associated therewith to enable later retrieval of such alarms and/or events. Caching of alarms and/or events can additionally facilitate rollback of field devices and/or industrial processes to a known good state. Pursuant to an example, each alarm and/or event generated by the alarm generator component 102 can be cached within the data repository through utilization of the buffering component 104. For instance, the alarm generator component 102 can create an alarm, and the buffering component 104 can place the alarm in the data repository 106. Additionally, an attempt can be made to transmit the alarm to an intended recipient. If the transmission fails (e.g., the intended recipient is offline), the alarm remains in the data repository 106 and later attempts can be made to transmit the alarm. After a threshold amount of time passes and/or capacity of the data repository 106 is below a threshold, the alarm can be deleted from the data repository 106.

In another example, the buffering component 104 can detect connectivity of the field device 100 and/or an intended recipient of the field device prior to determining whether the alarm should be cached within the data repository 106. For example, if a server is charged with maintaining alarms associated with several field devices, the buffering component 104 can ping the server to ensure that it is online. If the server is not online, the buffering component 104 can deliver a generated alarm to the data repository for caching 104. Thereafter, the buffering component 104 can monitor the server and when such server comes back online can cause the alarms within the data repository 106 to be pushed to such server. Additionally or alternatively, the server can pull alarms from the field device 100.

Still further, the buffering component 104 can provide an indication of urgency with respect to the alarm when placing the alarm within the data repository 106. For example, if the alarm relates to shutting down a production line for a significant amount of time, such alarm can be of significant urgency. In contrast, if the alarm relates to change of an operator, for instance, then the alarm may not be associated with high urgency. Alarms can be arranged by urgency within the data repository 106, and thereafter pushed to an intended recipient device when such device comes online.

The buffering component 104 can additionally buffer changes in alarm states. For example, if severity of an alarm changes over time, such state changes can be generated by the alarm generator component 102 and placed within the data repository 104 by the buffering component 104. Alarm states can thereafter be analyzed to determine source of an alarm, trends within data, and/or the like.

Turning now to FIG. 2, a field device 200 is illustrated, wherein alarms generated within the field device 200 can be buffered. The field device 200 includes a synchronization component 202 that can synchronize a clock 204 of the field device 200 with clocks of other field devices within a manufacturing environment. For example, clocks of field devices within a manufacturing environment can be synchronized, thereby creating a system-wide time. The synchronization component 202 can receive time indications from a master clock (not shown) that periodically provides field devices with a time. Such time can be based upon Greenwich Mean Time or any other suitable time standard. The master clock can be resident within a server or other component above the factory floor or can be resident within a different field device. In another example, the clock 204 of the field device 200 can act as a master clock with respect to one or more field devices that are communicatively coupled to the field device 200.

The field device 200 also includes the alarm generator component 102, which can create an alarm upon determining that data produced and/or consumed by the field device 200 lies outside a desired range and/or a particular user action is detected. Upon generation of an alarm, a timestamp generator 206 can create a timestamp and such timestamp can be associated with the alarm. Pursuant to an example, the alarm generator component 102 can package a timestamp created by the timestamp generator component 206 with the alarm. The buffering component 104 can then cause the alarm and the associated timestamp to be cached within the data repository 106.

Timestamping and caching alarms enables a series of alarms to be chronologically recreated if an industrial system has network problems and/or one or more servers go offline. For example, a server that manages alarms with respect to a plurality of field devices can go offline. Each of the field devices can create a plurality of alarms and/or an alarm created by one or more field devices can change states several times. If alarm data is not cached, then such alarm data will be lost. Additionally, as the clock 204 is synchronized with clocks of other field devices, timestamps generated by such field devices will be associated with timestamps created by the timestamp generator component 206 (and accord to a system-wide time). Alarms with associated timestamps can be buffered within the field devices at least until the aforementioned server comes online, and thereafter alarms and associated timestamps can be pushed to the server and/or pulled from the field devices by the server. The server can then chronologically arrange the alarms for analysis and/or rollback.

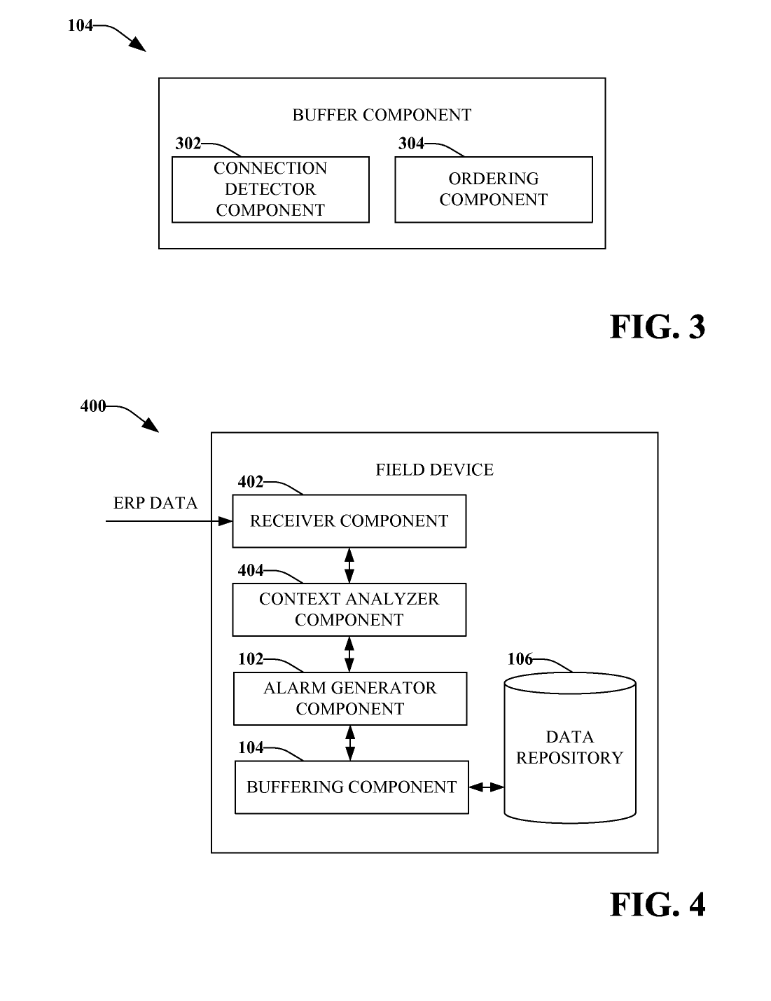

Turning now to FIG. 3, the buffer component 104 is shown in more detail. The buffer component 104, which resides within a field device, can include a connection detector component 302 that can monitor a connection between the field device that includes the buffer component 104 and a device that manages alarms and/or events, such as a server. For instance, the connection detector component 302 can send pings to a server that manages alarms created by a field device to determine whether such server is online. In another example, the server can periodically provide an indication to the connection detector component 302 that such server remains online. In yet another example, the buffer component 104 can buffer each generated alarm and await receipt of confirmation of receipt of the alarm by the server prior to removing the alarm from a cache.

The buffer component 104 can additionally include an ordering component 304 that can organize alarms within a cache. For example, the ordering component 304 can analyze an urgency level of alarms that are cached and can selectively place a newly created alarm within the cache as a function of the urgency level. More particularly, an alarm associated with high urgency would be placed in a cache in a position where it will be provided to a server or retrieved by the server prior to an alarm associated with low urgency. Additionally, the ordering component 304 can utilize a first in first out (FIFO) technique when ordering alarms, such that alarms are ordered within the cache by time. In yet another example, the ordering component 304 can order alarms according to a number of state changes associated with such alarms. Thus, an alarm with several state changes would be associated with higher priority than an alarm with no state changes, and the ordering component 304 can organize the alarms in a cache accordingly.

With reference now to FIG. 4, a field device 400 that can generate and cache alarms is illustrated. The field device 400 includes a receiver component 402 that can receive contextual data within an industrial system, including data from an Enterprise Resource Planning (ERP) system. Information from an ERP system can include ordering and/or inventory status, data relating to an operator (such as salary information), calendared events such as scheduled delivery of a manufactured product, and any other suitable data that can be received from an ERP system. The field device 400 additionally includes the alarm generator component 102, which can create an alarm upon data consumed and/or produced by the field device being outside an expected range and/or upon certain user actions. A context analyzer component 404 associated with the receiver component 402 and the alarm generator component 102 can analyze current and/or recent contextual data and provide such contextual data to the alarm generator component 102. The alarm generator component 102 can then package the alarm with contextual data deemed important by the context analyzer component.

Pursuant to an example, the field device 400 can be a controller and can receive temperature data from a sensor that lies outside of an expected range. The receiver component 102 can receive data relating to when a product is to be delivered as well as other ERP-related data, and the context-analyzer component 404 can provide the alarm generator component 102 with data relating to when the product is to be delivered. The alarm generator component 102 can request such data from the context analyzer component 404 and/or such data can be pushed to the alarm generator component 102 by the context analyzer component 404. The alarm generator component 102 can create an alarm pertaining to the temperature data and associate the ERP data with such alarm. Thus, ERP data (and other contextual data) can be packaged with alarm data and provided to a server (or other suitable device) for analysis.

The alarm generator component 102 is associated with the buffering component 104, which can selectively cache alarms. For instance, a server that manages and analyzes alarms may be offline; thus, the buffering component 104 can cache alarms created by the alarm generator component 102 within the data repository 106. When the server is back online, the alarms within the data repository 106 can be provided to the server for chronological recreation of alarms and/or analysis.

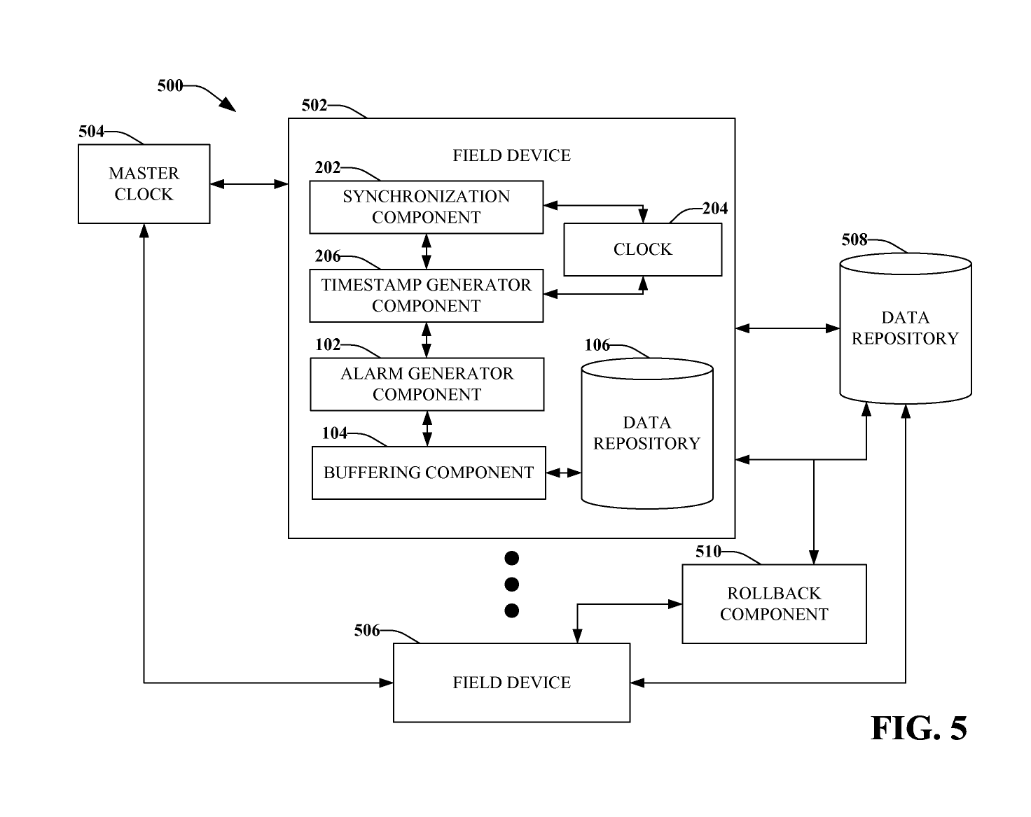

Now referring to FIG. 5, a system 500 that facilitates rollback of a field device or manufacturing process to a known good state is illustrated. The system 500 includes a field device 502 that comprises the synchronization component 202, which synchronizes the clock 204 with clocks of other field devices. More particularly, the synchronization component 202 can be communicatively coupled with a master clock 504, which provides a system-wide time to the field device 500 and at least one other field device 506. For example, the master clock 504 can periodically provide an indication of time to the field device 500 and the field device 506, such that clocks associated with the field devices 502 and 506 are synchronized with one another.

The system 500 additionally includes the alarm generator component 102, which can generate alarms if process variables are not within an expected range and/or if an operator undertakes certain action(s). The buffering component 104 can be utilized to cache one or more alarms created by the alarm generator component 102 within the data repository 106. In an example, the data repository 106 can be searched over to locate a particular alarm that has been cached. As described above, the buffering component 104 can cache each alarm created by the alarm generator component 102 and/or can cache alarms only when the field device 502 cannot establish a line of communication with a server that manages alarms.

The field devices 502 and 506 are associated with a data repository 508 that retains alarms generated from within such field devices 502 and 506. Additionally, as alarms created by the alarm generator component 102 are associated with a timestamp that accords to a synchronized time, such alarms can be placed within a correct chronological order. Events (such as an operator applying a digital signature, an operator signing off on a particular process, etc.) can also be associated with timestamps and placed within the data repository, and can be indexed according to time of creation (through analysis of timestamps), device, geographic location, process, or other suitable parameter.

The system 500 can additionally include a rollback component 510 that can rollback a process (e.g., one or more field devices working collaboratively to complete a task) to a known good state upon the process being associated with a failure. Pursuant to an example, several field devices can operate in conjunction to complete a task, and an alarm can initiate from one of such devices (e.g., an operator can depress an emergency stop button, initiating an alarm with respect to the field device 502). The alarm can cause a process variable to alter, giving rise to another alarm with respect to a different device, which can in turn cause a third alarm with respect to a third device. Since the alarms are associated with timestamps (that accord to a system-wide time) and are provided to the data repository 508, the rollback component 510 can determine a correct chronological order of the alarm (and dependencies of alarms). The rollback component 510 can then rollback the process to a known good state (e.g., to a state that existed prior to the operator depressing the emergency stop). Thus, rather than an operator manually reviewing several alarms to determine sequence and associations between alarms to determine where to rollback a process, the rollback component 510 can undertake such rollback automatically.

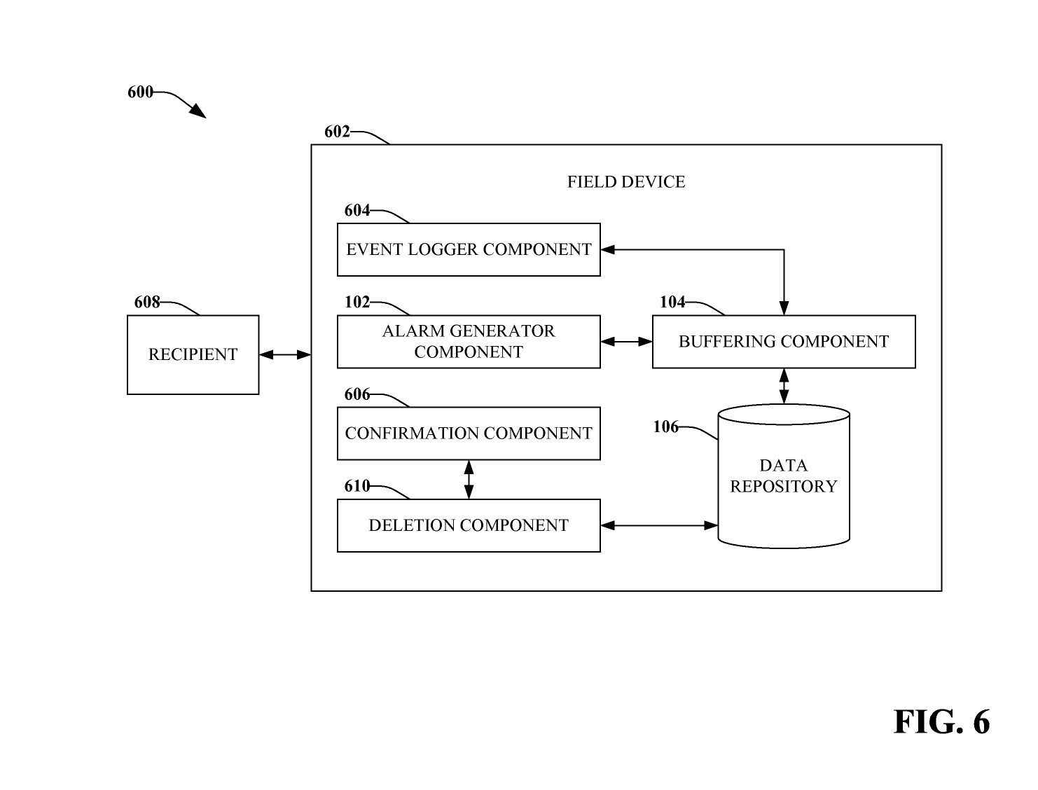

With reference to FIG. 6, a system 600 that facilitates caching alarms/events within an industrial automation system is illustrated. The system 600 includes a field device 602 that comprises an event logger component 604, which logs events that are related to the field device 602. For example, when an operator “signs off” on a particular batch, such signing off can be logged as an event (and timestamped). It may be desirable to provide a logged event to an external device, such as a server that manages alarms and events. Accordingly, the buffering component 104 can be utilized to at least temporarily cache a logged event within the data repository 106, particularly if the aforementioned server is offline.

The field device 602 additionally includes the alarm generator component 102. As described above, the alarm generator component 102 can create an alarm and associate such alarm with a timestamp upon a process variable being outside a desired range, a particular user action, etc. The alarm generator component 102 is associated with the buffering component 104, which can cache alarms created by the alarm generator component 102 for a predetermined amount of time, until a confirmation is received from a device or individual that is to see the alarm, or other suitable parameter. A confirmation component 606 can be employed to confirm that an intended recipient 608 has received an alarm created by the alarm generator component 102. Pursuant to an example, the recipient 608 can be a server that informs the confirmation component 606 that an alarm has been received. If no confirmation is received within a particular amount of time after generation of an alarm, then the confirmation component 606 can inform the buffering component 104 that such alarm should be cached. In another example, an alarm may be desirably provided to a particular human being for review. The alarm can be cached by the buffering component 104 until the confirmation component 606 receives a confirmation that the human being has reviewed the alarm. Once the confirmation is received, a deletion component 610 can remove the alarm from the data repository 106 that is local to the field device 602. Thus, space is available for alarms where confirmation of receipt has not been received.

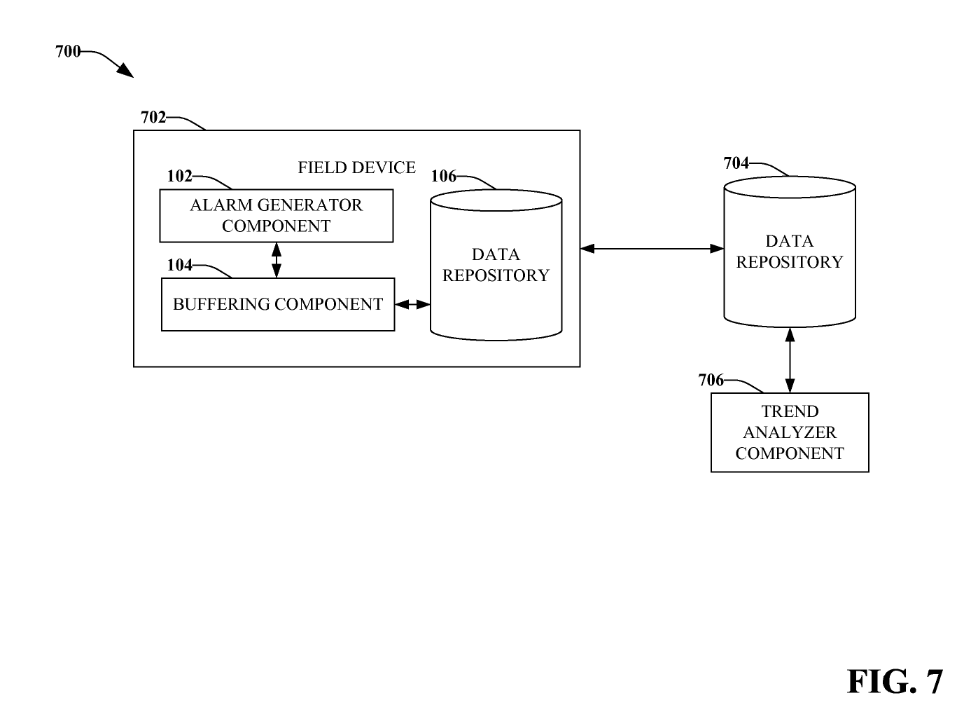

Turning now to FIG. 7, a system 700 that facilitates analyzing alarms to aid in determining sources of problems, workarounds to problems, more efficient mechanisms for completing a task, and the like is illustrated. The system 700 includes a field device 702 that comprises the alarm generator component 102. The alarm generator component 102 is communicatively coupled to the buffering component 104, which can selectively cache alarms by placing such alarms in the data repository 106 that is within the field device 702. Additionally, the field device 102 can be configured to provide alarms created by the alarm generator component 102 to a data repository 704 that is external to the field device 702. The data repository 704 can also be communicatively coupled to one or more other field devices, such that the data repository 704 includes alarm/event information associated with multiple field devices. Additionally, each alarm within the data repository 704 can be associated with a timestamp that accords to a universal, system-wide time, an indication of device or origin, process associated with the device, geographic location (zone) associated with the device, and other suitable parameters.

A trend analyzer component 706 can analyze contents of the data repository 704 to discern patterns therein. Such patterns can be utilized to locate origin of a problem, determine efficiencies associated with certain operators, processes, or devices, aid in determining workarounds, altering workflows, and/or the like. The trend analyzer component 706 can utilize machine-learning techniques to discern patterns associated with alarms/events retained within the data repository 704, such as Bayesian Networks, Artificial Neural Networks, a k-nearest neighbor approach, Support Vector Machines, any suitable classifier, etc. Additionally, the trend analyzer component 706 can recognize beginning of trends and can cause corrective action to be undertaken prior to a problem coming to fruition.

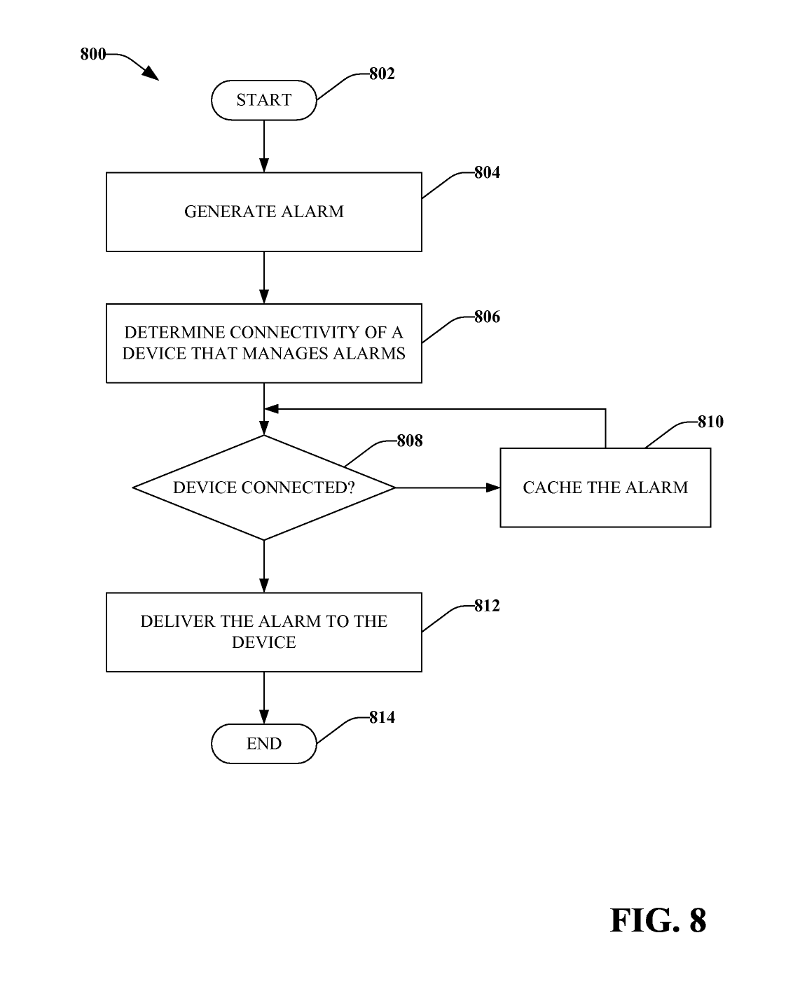

Turning to FIGS. 8-10, methodologies relating to caching alarms are illustrated. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring specifically to FIG. 8, a methodology 800 for at least temporarily caching an alarm within a field device is illustrated. The methodology 800 starts at 802, and at 804 an alarm is generated. As described above, the alarm can be created when a process variable lies outside an expected range, when a user undertakes a particular action, and/or the like. Additionally, the alarm can be generated within a field device, such as a logic controller, a robotic controller, a press, a pump, and/or the like. At 806, connectivity of a device that manages alarms is determined. Pursuant to an example, a server can be tasked with maintaining alarms for analysis, and the connectivity of the server can be ascertained. In another example, a controller might desirably provide an alarm to a second controller, and connectivity of the second controller can be ascertained. For instance, the first controller can ping the second controller.

At decision block 808 a determination is made regarding whether the relevant device is connected to the device generating the alarm. If the device is not connected, then at 810 the alarm can be cached. For instance, the device generating the alarm can include a local data repository, and the alarm can be cached within such repository. Once the alarm is cached, connectivity of the relevant device can be periodically checked. If the relevant device is connected, then at 812 the alarm can be provided to such device. The methodology 800 then completes at 814.

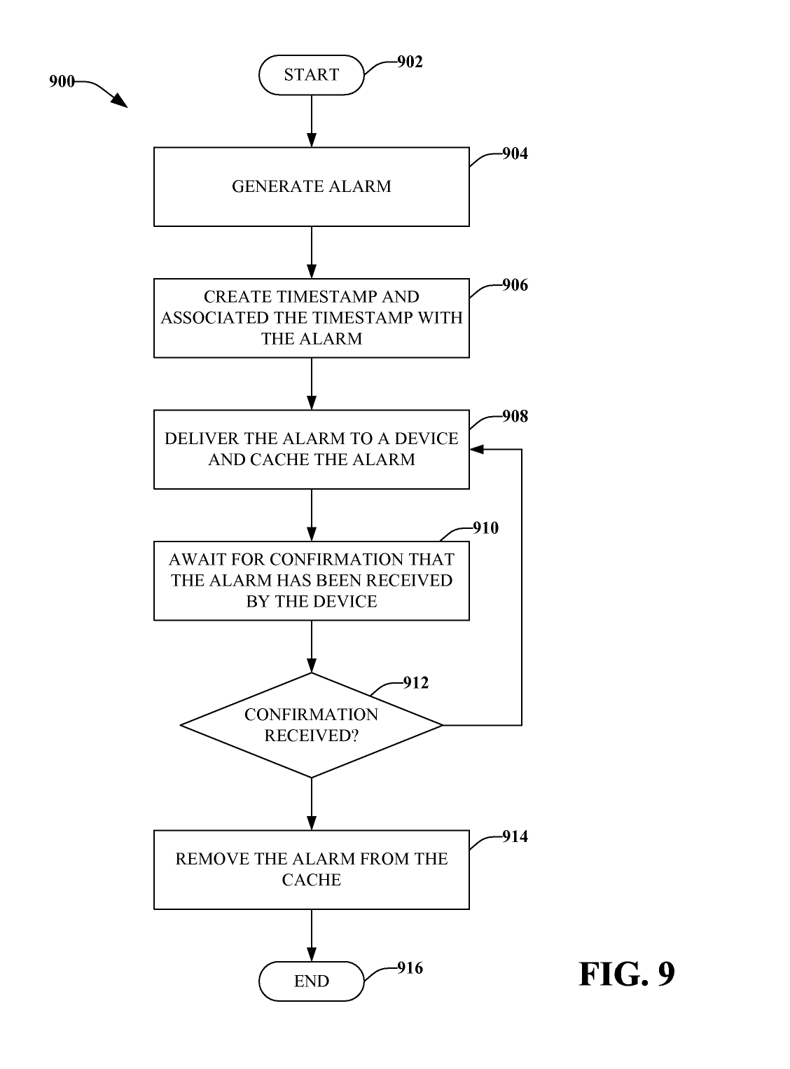

With reference now to FIG. 9, a methodology 900 for selectively caching alarms within a field device is illustrated. The methodology 900 starts at 902, and at 904 an alarm is generated. At 906, a timestamp is created and associated with the alarm. The timestamp can be created through utilization of a clock within a field device that generates the alarm, wherein the clock is synchronized with at least one other clock. Pursuant to an example, a manufacturing process can include several synchronized devices, thereby creating a standardized, universal time. This timestamping of alarms enables alarms to be chronologically recreated in a correct manner. At 908, the alarm is delivered to an intended device as well as cached internal to the device that generated the alarm. At 910, receipt of confirmation that the alarm has been received is awaited upon at the device that generated the alarm. At 912, a determination is made regarding whether the conformation has been received. If the confirmation has not been received, then the methodology 900 returns to 908, such that the alarm can be delivered again and confirmation of receipt of the alarm can be awaited. If at 912 it is determined that confirmation has been received, then at 914 the alarm is removed from the cache. The methodology 900 then completes at 916.

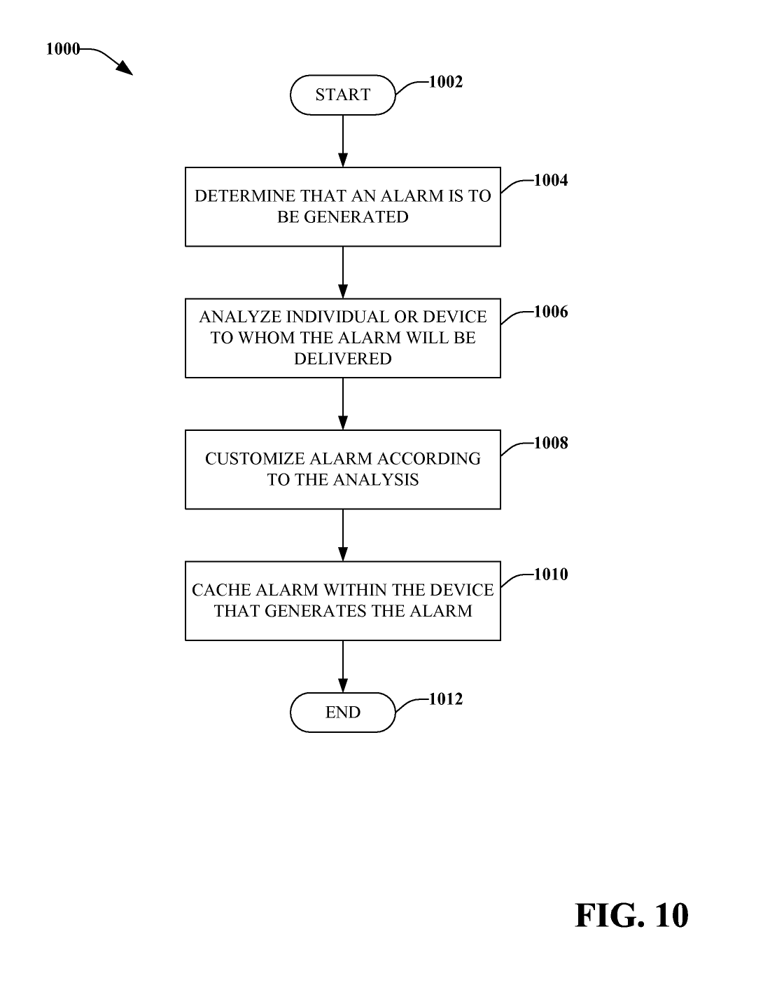

Turning now to FIG. 10, a methodology 1000 for caching an alarm is illustrated. The methodology 1000 initiates at 1002, and at 1004 a determination is made that an alarm is to be generated. For instance, it can be determined that a process variable lies outside a certain threshold. In another example, a user can depress a push-button that causes a process to immediately halt. At 1006, an individual and/or device with respect to which the alarm is to be provided are analyzed. For example, a database can be accessed that includes information relating to a user, such as user role (e.g., job function, location in a corporate hierarchy, . . . ), access privileges with respect to certain data, user location, user preferences (such as language preferences), and/or the like. Additionally, device information can be ascertained, such as screen real-estate, resolution capabilities, color capabilities, programs on the device for rendering graphics, etc. This and other information that can be utilized to selectively provide an alarm can be determined.

At 1008, an alarm is customized according to the analysis. Moreover, a single event can cause generation of an alarm that is intended for several parties, wherein the alarm can be customized for each of the several parties. In an example, it may be desirable to provide an alarm to a line operator in the United States who will receive the alarm on a human-machine interface (HMI) as well as to an executive in Japan who will receive the alarm on a cellular telephone. Thus, the alarm can be provided to the operator in English while maximizing screen real-estate and resolution capabilities with content that is associated with the operator, while the executive can be provided the alarm in Japanese in a manner suitable for viewing on a mobile telephone. At 1010, the alarm is cached within the device generating the alarm. The methodology 1000 then completes at 1012.

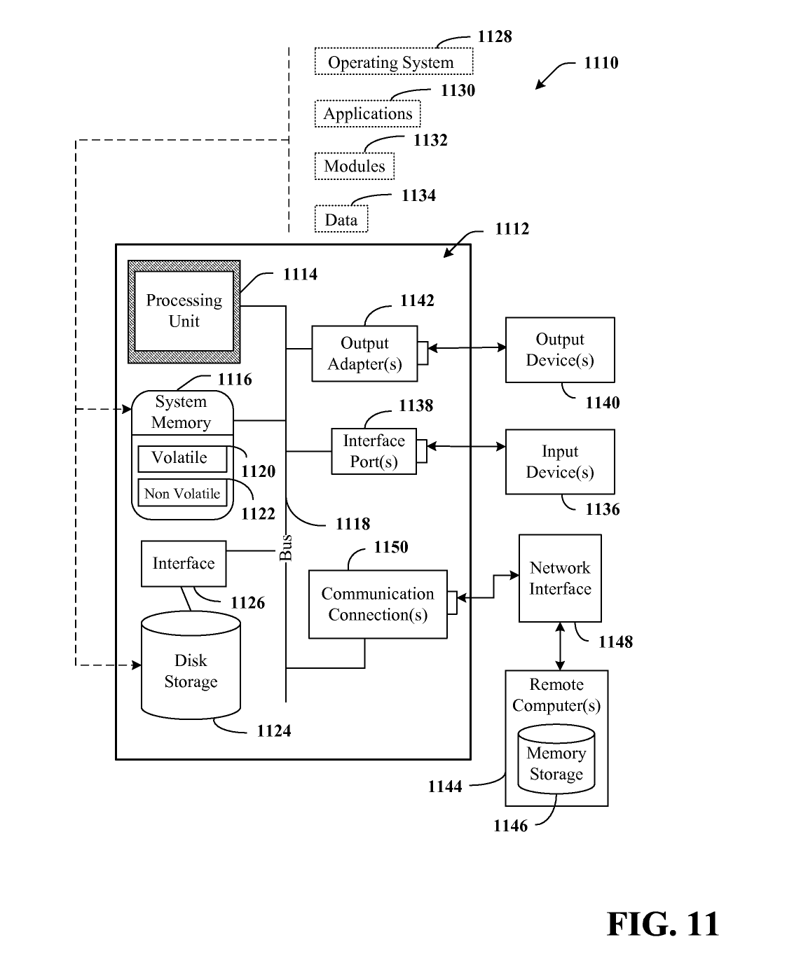

With reference to FIG. 11, an example environment 1110 for implementing various aspects of the aforementioned subject matter, including creating alarms and timestamps, includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable PROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/non-removable, volatile/non-volatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the subject invention can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies include Fiber Distributed Data Interface (FDDI), Copper Distributed Data Interface (CDDI), Ethemet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

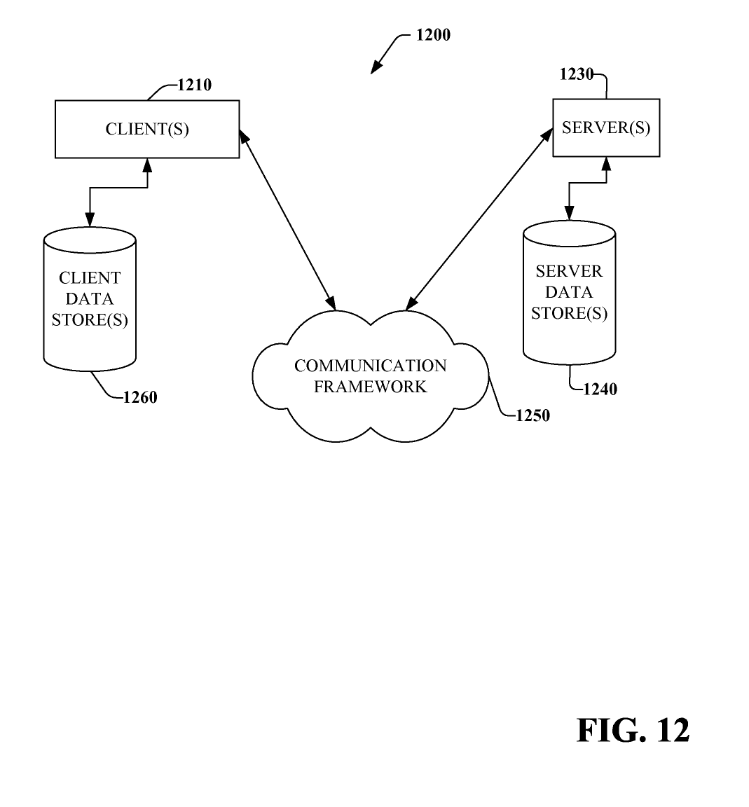

FIG. 12 is a schematic block diagram of a sample-computing environment 1200 with which the disclosed subject matter can interact. The system 1200 includes one or more client(s) 1210. The client(s) 1210 can be hardware and/or software (e.g., threads, processes, computing devices). The system 1200 also includes one or more server(s) 1230. The server(s) 1230 can also be hardware and/or software (e.g., threads, processes, computing devices). The servers 1230 can house threads to perform transformations by employing the subject invention, for example. One possible communication between a client 1210 and a server 1230 can be in the form of a data packet adapted to be transmitted between two or more computer processes. The system 1200 includes a communication framework 1250 that can be employed to facilitate communications between the client(s) 1210 and the server(s) 1230. The client(s) 1210 are operably connected to one or more client data store(s) 1260 that can be employed to store information local to the client(s) 1210. Similarly, the server(s) 1230 are operably connected to one or more server data store(s) 1240 that can be employed to store information local to the servers 1230.

What has been described above includes examples of the claimed subject matter. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An industrial field device, comprising:
an alarm generator component that creates an alarm relating to the industrial field device; and
a buffering component that selectively caches the alarm within a data repository.

2. The field device of claim 1 being an industrial controller.

3. The field device of claim 1 being a network infrastructure device.

4. The field device of claim 1, the data repository is local to the industrial field device.

5. The field device of claim 1, further comprising:
a synchronization component that synchronizes a clock of the industrial field device with a clock of at least one other industrial field device to create a synchronized time; and
a timestamp generator component that creates a timestamp upon the alarm generator component creating the alarm and associates the timestamp with the alarm, the timestamp accords to the synchronized time.

6. The field device of claim 1, the synchronization component receives an indication of a system-wide time from a master clock that is communicatively coupled thereto.

7. The field device of claim 1, further comprising a connection detector component that determines connectivity status of a device with respect to which the alarm is desirably provided, the buffering component 302 caches the alarm if the device is not associated with sufficient connectivity.

8. The field device of claim 7, further comprising an ordering component that selectively orders alarms within the data repository based upon priority associated with the alarms.

9. The field device of claim 1, further comprising:
a receiver component that receives contextual data; and
a context analyzer component that analyzes the contextual data and provides pertinent contextual data to the alarm generator, the alarm generator creates the alarm based at least in part upon the analysis.

10. The field device of claim 9, the received contextual data comprises Enterprise Resource Planning System (ERP) data, the alarm generator component includes at least a portion of the received ERP data within the alarm.

11. The field device of claim 1, further comprising a rollback component that rolls back a state of the industrial field device to a known good state.

12. The field device of claim 1, further comprising a confirmation component that confirms that an intended recipient of the alarm has received the alarm.

13. The field device of claim 12, further comprising a deletion component that removes the alarm from the data repository upon the confirmation component confirming that the intended recipient of the alarm has received the alarm.

14. The field device of claim 1 being associated with a trend analyzer component that analyzes a plurality of alarms to determine trends associated therewith.

15. The field device of claim 1, further comprising an event logger component that logs industrial events, the buffering component selectively caches events within the data repository.

16. A method for selectively caching alarms, comprising:
generating an alarm within an industrial field device; and
buffering the alarm within the industrial field device.

17. The method of claim 16, further comprising buffering the alarm within the industrial field device when it is determined that a device that is desirably provided the alarm is not associated with sufficient connectivity.

18. The method of claim 16, further comprising:
attempting to deliver the alarm to a device that is desirably provided the alarm;
awaiting receipt of confirmation from the device that the alarm has been received; and
buffering the alarm until confirmation has been received.

19. The method of claim 18, further comprising attempting to deliver the alarm to the device again after a threshold amount of time has passed without receipt of conformation from the device.

20. The method of claim 16, further comprising associating the alarm with a timestamp, a clock utilized to create the timestamp is synchronized with at least one other industrial field device.

21. The method of claim 16, further comprising:
analyzing preferences of a user to which the alarm is desirably provided; and
generating the alarm based at least in part upon the analysis.

22. A logic controller configured to perform the methodology of claim 16.

23. A system, comprising:
means for generating an alarm within an industrial field device; and
means for selectively buffering the alarm within the industrial field device if a device that is desirably provided the alarm is not associated with sufficient connectivity.
